(19) United States
(12) Patent Application Publication
(10) Pub. No.: US 2026/0251270 A1
(43) Pub. Date: Aug. 27, 2026

(54) PRESSURE VESSEL FOR STORING A PRESSURISED FLUID, SUCH AS HYDROGEN

(71) Applicant: TENARIS CONNECTIONS B.V., Amsterdam (NL)

(72) Inventors: Miguel Angel Rossi, Buenos Aires (AR); Michele Sileo, Dalmine (IT); Nestor Jesus Santi, Buenos Aires (AR)

(73) Assignee: TENARIS CONNECTIONS B.V., Amsterdam (NL)

(21) Appl. No.: 19/163,645

(22) PCT Filed: Mar. 7, 2024
(86) PCT No.: PCT/EP2024/056053

§ 371 Date: Sep. 9, 2025

(30) Foreign Application Priority Data
Mar. 10, 2023 (NL) 2034319

(51) Int. Cl. F17C 13/06

(52) U.S. Cl. CPC F17C 13/06; F17C 2205/0305; F17C 2205/0311; F17C 2221/012; F17C 2223/036

(57) ABSTRACT

A pressure vessel for storing a pressurised fluid, such as hydrogen, the pressure vessel comprising a shell comprising an access port provided with a port sealing surface, and a cap provided with a cap sealing surface and defining a longitudinal axis, wherein the access port and the cap are configured to receive and hold the cap in the access port with the cap sealing surface and the port sealing surface contacting each other to form an internal seal, the cap comprises an inner cap end, a recess is provided in the inner cap end, such that an axial extension is formed, and the cap sealing surface is provided at the axial extension.

### FIELD OF THE INVENTION

The invention relates to a pressure vessel for storing a pressurised fluid, such as hydrogen. Such a pressure vessel comprises a shell having an access port that provides access to an internal storage space of the pressure vessel, and a cap arranged for closing the access port. An internal seal is formed between the access port and the cap in order avoid that the pressurized fluid stored in the pressure vessel will leak out of the pressure vessel.

### BACKGROUND OF THE INVENTION

The invention is based on the insight that there is a need in the field of the art for a pressure vessel having an internal seal that is less susceptible to damage. Damage to the internal seal may lead to dangerous situations caused by leakage of the pressurised fluid. This is especially the case when the pressurised fluid is a highly flammable fluid, such as hydrogen.

### SUMMARY OF THE INVENTION

The invention has the objective to provide an improved, or at least alternative, pressure vessel, method, and cap. In particular, the invention has the objective to provide a pressure vessel having an internal seal that is less susceptible to damage.

The objective is achieved by a pressure vessel for storing a pressurised fluid, such as hydrogen. The pressure vessel comprises a shell comprising an access port provided with a port sealing surface, and a cap provided with a cap sealing surface and defining a longitudinal axis. The access port and the cap are configured to receive and hold the cap in the access port with the cap sealing surface and the port sealing surface contacting each other to form an internal seal. The cap comprises an inner cap end, wherein a recess is provided in the inner cap end, such that an axial extension is formed. The cap sealing surface is provided at the axial extension.

By providing a pressure vessel cap wherein a recess is provided in the inner cap end, thereby forming an axial extension, and wherein the cap sealing surface is provided at the axial extension, the seal is located at a portion of the cap that may have much greater flexibility in radial direction as opposed to other portions of the cap. In addition, as the axial extension is adjacent to the recess, the seal can be in part actuated by the pressurized fluid acting on the axial extension. Accordingly, the invention allows to design a seal, whereat high stress concentrations that could lead to damage at the seal may be omitted, while ensuring sufficient sealing contact in loaded condition of the pressure vessel. Hence, with the present invention, the seal may be less susceptible to damage.

It was an insight of the inventors that reducing stresses, in particular tensile stresses, at the internal seal is particularly important for pressure vessels employing an internal seal that is subjected to pressurized hydrogen, as material degradation due to hydrogen adsorption may be accelerated when high material stresses are present at the internal seal.

Within the context of the present disclosure, with “inner cap end” is generally meant: the longitudinal end of the cap that is to be received inside the pressure vessel.

Advantageous embodiments of the present invention are described in the following.

In an embodiment of the pressure vessel according to the invention, the axial extension surrounds the recess, in particular, in radial direction with respect to the longitudinal axis.

In an embodiment of the pressure vessel according to the invention, the axial extension is radially outward with respect to the recess. In particular, the axial extension is with respect to the longitudinal axis located radially outward of the recess. As such, the axial extension may be more flexible in radial direction.

In an embodiment of the pressure vessel according to the invention, the axial extension comprises an inner extension side facing towards the longitudinal axis, wherein the inner extension side forms a boundary of the recess. In particular, the inner extension side may form a radial boundary of the recess.

In an embodiment of the pressure vessel according to the invention, the axial extension is an annular axial extension. In particular, the annular axial extension may have an annular cross section, in particular when viewed in longitudinal direction with respect to the longitudinal axis of the cap. In particular, the annulus of the annular axial extension is endless.

In an embodiment of the pressure vessel according to the invention, the recess has an annular shape. In particular, the recess may have an annular shape when viewed in longitudinal direction with respect to the longitudinal axis of the cap.

In an embodiment of the pressure vessel according to the invention, the cap comprises an inner recess surface. Such inner recess surface forms a boundary of the recess. In particular, the inner recess surface may extend perpendicular with respect to the longitudinal axis of the cap.

In an embodiment of the pressure vessel according to the invention, the axial extension extends in axial direction with respect to the longitudinal axis. In particular, the axial extension extends away from the inner recess surface.

In an embodiment of the pressure vessel according to the invention, the cap comprises a duct having an inner duct opening, wherein the axial extension is radially spaced from the inner duct opening. In particular, the axial extension surrounds the inner duct opening, more in particular, in radial direction with respect to the longitudinal axis.

In an embodiment of the pressure vessel according to the invention, the inner duct opening is provided at the inner recess surface.

In an embodiment of the pressure vessel according to the invention, the inner duct is located at, and aligned with, the longitudinal axis of the cap.

In embodiments comprising a duct, it is possible to configure seal parameters of the internal seal independently of the duct, more specifically independently of characteristics of the duct, such as specific dimensions (e.g. the diameter or length) of the duct. This is possible because characteristics of the axial extension, such as specific dimensions (e.g. the cap extension thickness) of the axial extension can be configured independently of the duct. As such, it is for example possible to adjust the flexibility in radial direction of the axial extension having the cap sealing surface, without influencing dimensions of the duct. Adjusting the flexibility of the axial extension will lead to adjusted seal parameters of the internal seal formed by the cap sealing surface and the port sealing surface contacting each other. This allows that seal parameters are selected which are favourable for reducing damage to the internal seal.

In an embodiment of the pressure vessel according to the invention, the axial extension extends in axial direction with respect to the longitudinal axis away from the duct.

In an embodiment of the pressure vessel according to the invention, the cap sealing surface is provided on the axial extension.

In an embodiment of the pressure vessel according to the invention, the cap sealing surface is axially spaced from the inner recess surface. In particular, the cap sealing surface is spaced from the inner recess surface in axial direction along the longitudinal axis.

In an embodiment of the pressure vessel according to the invention, the port sealing surface is axially spaced from the inner recess surface. In particular, the port sealing surface is spaced from the inner recess surface in axial direction along the longitudinal axis.

In an embodiment of the pressure vessel according to the invention, the inner recess surface extends transverse to the longitudinal axis.

In an embodiment of the pressure vessel according to the invention, the internal seal is a metal-to-metal seal. The metal-to-metal seal is less susceptible to damage, in particular, in cases where the pressure vessel is exposed to high temperature changes, when compared to elastomeric seals. As a result, the metal-to-metal seal has a high thermal stability.

In an embodiment of the pressure vessel according to the invention, the duct is configured to facilitate a flow of the pressurised fluid, such as hydrogen, in and/or out of the pressure vessel.

In an embodiment of the pressure vessel according to the invention, the cap comprises an outer duct opening and the duct extends from the inner duct opening until the outer duct opening.

In an embodiment of the pressure vessel according to the invention, the axial extension surrounds the longitudinal axis completely.

In an embodiment of the pressure vessel according to the invention, the inner recess surface is in radial direction with respect to the longitudinal axis located between the inner duct opening and the axial extension.

In an embodiment of the pressure vessel according to the invention, the axial extension comprises an adjoining end adjacent to the inner recess surface and a free end axially distanced from the inner recess surface.

In an embodiment of the pressure vessel according to the invention, the cap comprises a cap body, the cap body comprises a circumferential cap surface surrounding the longitudinal axis, and the axial extension comprises a cap extension thickness measured in radial direction with respect to the longitudinal axis at the axial extension, the cap body comprises a cap body thickness measured in radial direction with respect to the longitudinal axis from the longitudinal axis until the circumferential cap surface, and the cap extension thickness is smaller than the cap body thickness. In embodiments wherein the cap comprises a duct, the duct is provided in the cap body, and the cap body thickness is measured in radial direction with respect to the longitudinal axis from the duct until the circumferential cap surface. These embodiments allow that the axial extension is constructed with a higher flexibility than the cap body. This is beneficial to ensure that the seal parameters are mainly determined by the axial extension when compared with the cap body. The cap extension thickness may be the smallest cap extension thickness measured at the axial extension in the radial direction. The smallest cap extension thickness may be measured at an extension part of the axial extension extending in axial direction from, and including, the cap sealing surface until the adjoining end. The cap body thickness may be the smallest cap body thickness measured at the cap body, in particular, from the duct until the circumferential cap surface in the radial direction. The smallest cap body thickness may be measured at the inner recess surface.

In an embodiment of the pressure vessel according to the invention, the axial extension comprises a cap extension bending stiffness at the cap extension thickness, the cap body comprises a cap body bending stiffness at the cap body thickness, and the cap extension bending stiffness is smaller than the cap body bending stiffness.

In an embodiment of the pressure vessel according to the invention, the axial extension and the cap body are made from a same material, such as a same metal, and wherein preferably the axial extension and the cap body are integrally formed. Thus, the axial extension can be integrally formed with the cap body. Accordingly, the axial extension and the cap body can be made of a single piece or formed into a single piece.

In an embodiment of the pressure vessel according to the invention, the cap comprises an inner cap section configured to be located inside the access port and an outer cap section configured to be located outside the access port.

In an embodiment of the pressure vessel according to the invention, the axial extension and the cap body are part of the inner cap section.

In an embodiment of the pressure vessel according to the invention, the inner duct opening is located at the inner cap section and the outer duct opening is located at the outer cap section.

In an embodiment of the pressure vessel according to the invention, the axial extension extends away from the outer cap section.

In an embodiment of the pressure vessel according to the invention, the duct has a circular cross section. In particular, the duct is circular when viewed in a cross sectional view in a plane perpendicular to the longitudinal axis.

In an embodiment of the pressure vessel according to the invention, the duct extends in line with the longitudinal axis.

In an embodiment of the pressure vessel according to the invention, the axial extension comprises an inner extension side facing towards the longitudinal axis and an outer extension side facing away from the longitudinal axis and the cap sealing surface is located at the outer extension side.

In an embodiment of the pressure vessel according to the invention, the cap sealing surface surrounds the longitudinal axis completely.

In an embodiment of the pressure vessel according to the invention, the axial extension comprises an inner extension surface facing towards the longitudinal axis and a transition surface connecting (or adjoining) the inner extension surface with the inner recess surface, and the transition surface forms a rounded corner extending along a radius R when viewed in a longitudinal sectional view with respect to the longitudinal axis. This provides additional structural integrity to the axial extension.

In an embodiment of the pressure vessel according to the invention, the access port defines a further longitudinal axis and the port sealing surface faces towards the further longitudinal axis.

In an embodiment of the pressure vessel according to the invention, the port sealing surface surrounds the further longitudinal axis completely.

In an embodiment of the pressure vessel according to the invention, the access port is provided in a neck of the shell. In particular, the access port may comprise an outer port surface having an outer port surface diameter, wherein the outer port surface diameter is smaller than a largest outer diameter of the shell. Similarly, the port sealing surface may be provided at an inner port sealing surface diameter that is smaller than a largest inner shell diameter.

In an embodiment of the pressure vessel according to the invention, the axial extension comprises a cap extension thickness measured in radial direction with respect to the longitudinal axis at the axial extension, the access port comprises an outer port surface and a port thickness measured in a further radial direction with respect to the further longitudinal axis from the port sealing surface until the outer port surface, and the port thickness is larger than the cap extension thickness. This allows that the axial extension is constructed with a higher flexibility than the access port. This tends to ensure that if the internal seal is damaged, most of the damage will occur at the cap, more specifically at the axial extension, rather than at the access port. The cap extension thickness may be the smallest cap extension thickness measured at the axial extension in the radial direction. The smallest cap extension thickness may be measured at an extension part of the axial extension extending in axial direction from, and including, the cap sealing surface until the adjoining end. The port thickness may be the smallest port thickness measured at the access port in the further radial direction. The smallest port thickness may be measured at the port sealing surface.

In an embodiment of the pressure vessel according to the invention, the access port comprises a port bending stiffness at the port thickness, the axial extension comprises a cap extension bending stiffness at the cap extension thickness, and the port bending stiffness is higher than the cap extension bending stiffness.

In an embodiment of the pressure vessel according to the invention, the access port and the axial extension and made from a same material, such as a same metal.

In an embodiment of the pressure vessel according to the invention, the access port comprises a female threaded zone, and the cap comprises a male threaded zone. In such embodiment, the female threaded zone and the male threaded zone are configured for rotational engagement with each other to receive and hold the cap in the access port with the cap sealing surface and the port sealing surface contacting each other to form the internal seal. Such embodiment works in particular well in combination with an embodiment wherein the cap body is integrally formed with the axial extension, because in such case the port sealing surface may be accurately positioned with respect to the cap sealing surface.

In an embodiment of the pressure vessel according to the invention, the access port comprises an outer access opening and a female threaded zone, the cap comprises a male threaded zone, the female threaded zone and the male threaded zone are configured for rotational engagement with each other, and the female threaded zone is located closer to the outer access opening than the port sealing surface. An advantage of this embodiment is that the threaded zones are not exposed to the pressurized fluid, in particular the hydrogen stored in the pressure vessel.

In an embodiment of the pressure vessel according to the invention, the female threaded zone and the male threaded zone comprise non-tapered threads.

In an embodiment of the pressure vessel according to the invention, the female threaded zone is located closer to the outer access opening than the port sealing surface, in particular, when viewed along the further longitudinal axis.

In an embodiment of the pressure vessel according to the invention, the access port and the cap are free from a seal located closer to the outer access opening than the female threaded zone.

In an embodiment of the pressure vessel according to the invention, the access port and the cap are free from an external seal.

An advantage of the above embodiments is, that, in case of internal seal failure, hydrogen may be released from the hydrogen pressure vessel immediately along the threaded zones, as opposed to becoming trapped at the threaded zones. Trapped hydrogen may form a safety hazard.

In an embodiment of the pressure vessel according to the invention, the cap sealing surface is toroidal. In particular, the cap sealing surface may be convex. More in particular, the cap sealing surface may have a convex longitudinal section, in particular when viewed in a longitudinal sectional view with respect to the longitudinal axis.

In an embodiment of the pressure vessel according to the invention, the port sealing surface is conical.

In an embodiment of the pressure vessel according to the invention, the conical port sealing surface becomes wider in a first direction along the further longitudinal axis of the access port and towards the outer access opening.

In an embodiment of the pressure vessel according to the invention, the access port and the cap are free from an elastomeric seal.

In an embodiment of the pressure vessel according to the invention, the access port and the cap are configured to hold the cap in a sealing position in the access port with the cap sealing surface and the port sealing surface contacting each other to form the internal seal.

In an embodiment of the pressure vessel according to the invention, the access port comprises a port stop shoulder, the cap comprises a cap stop shoulder, and the port stop shoulder and the cap stop shoulder are configured to contact each other to form the internal seal when the cap is located in the sealing position. In particular, the cap stop shoulder is located at a distance from the axial extension. More in particular, the cap stop shoulder is provided on the outer cap section. In particular, the port stop shoulder is located at the outer access opening. More in particular, the port stop shoulder is, in longitudinal direction along the further longitudinal axis, located further from the port sealing surface than the female threaded zone is located from the port sealing surface.

In an embodiment of the pressure vessel according to the invention, the longitudinal axis of the cap positioned in the sealing position coincides with the further longitudinal of the access port.

In an embodiment of the pressure vessel according to the invention, the pressure vessel is configured to store the pressurised fluid at a fluid pressure of 500 bar or higher, preferably 1000 bar or higher.

In an embodiment of the pressure vessel according to the invention, the access port provides access to a storage space for storing the pressurised fluid in the pressure vessel.

In an embodiment of the pressure vessel according to the invention, a valve, such as a pressure valve, is connected to the duct. Such valve is arranged to control the flow of fluid in and/or out of the pressure vessel.

It will be clear to the skilled person that the invention also relates to embodiments of the pressure vessel comprising the features of any combination of any number of the above defined embodiments of the pressure vessel according to the invention.

The invention further relates to a pressure vessel for storing a pressurised fluid, such as hydrogen, said pressure vessel comprising a shell comprising an access port provided with a port sealing surface, and a cap provided with a cap sealing surface and defining a longitudinal axis, wherein the access port and the cap are configured to receive and hold the cap in the access port with the cap sealing surface and the port sealing surface contacting each other to form an internal seal, the cap comprises an inner cap surface and a duct having an inner duct opening provided at the inner cap surface, the cap further comprises an axial extension extending in axial direction with respect to, in particular from, the inner cap surface, and the cap sealing surface is provided at the axial extension. In particular, the axial extension may be adjoining the inner cap surface.

It will be clear to the skilled person that the invention also relates to embodiments of the above pressure vessel comprising the features of the pressure vessel of any combination of any number of the above defined embodiments of the pressure vessel according to the invention.

The invention further relates to a method for sealing a pressure vessel for storing a pressurised fluid, such as hydrogen, according to the invention, the method comprising placing the cap in the access port and forming an internal seal with the cap sealing surface and the port sealing surface contacting each other.

It will be clear to the skilled person that the invention also relates to embodiments of the method comprising the features of the pressure vessel of any combination of any number of the above defined embodiments of the pressure vessel according to the invention.

The invention further relates to a cap for a pressure vessel, comprising an inner cap end, a recess provided in the inner cap end, such that an axial extension is formed, and a cap sealing surface provided at the axial extension.

It will be clear to the skilled person that the invention also relates to embodiments of the cap comprising the features of the cap of any combination of any number of the above defined embodiments of the pressure vessel according to the invention.

### BRIEF DESCRIPTION OF THE DRAWINGS

Embodiments of the pressure vessel according to the invention, the method according to the invention and the cap according to the invention will be described by way of example only, with reference to the accompanying schematic drawings in which corresponding reference symbols indicate corresponding parts, and in which:

FIG. 1 schematically shows a view in perspective of an embodiment of the pressure vessel according to the invention,

FIG. 2 schematically shows a view in longitudinal section of the pressure vessel of FIG. 1,

FIG. 3A schematically shows a view in longitudinal section of an access port and a cap of the pressure vessel of FIG. 1,

FIG. 3B schematically shows an enlarged view of part III-B of FIG. 3A,

FIG. 3C schematically shows the view of FIG. 3B presenting results of a finite element analysis,

FIG. 4A schematically shows a longitudinal sectional view of the access port of FIG. 3A,

FIG. 4B schematically shows an enlarged view of part IV-B of FIG. 4A,

FIG. 5A schematically shows a view in longitudinal section of the cap of FIG. 3A,

FIG. 5B schematically shows an enlarged view of part V-B of FIG. 5A,

FIG. 6 schematically shows a view in longitudinal section of a further access port and a further cap of the pressure vessel of FIG. 1, and

FIG. 7 schematically shows a view in longitudinal section of another embodiment of a cap in accordance with the invention.

### DETAILED DESCRIPTION OF THE DRAWINGS

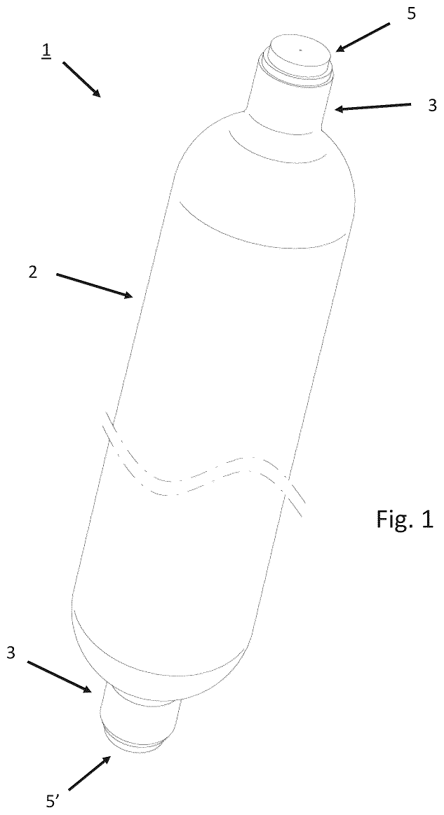

FIG. 1 shows a view in perspective of an embodiment of the pressure vessel 1 according to the invention. The pressure vessel 1 is configured to store a pressurised fluid, more specifically hydrogen. The pressure vessel 1 is configured to store the pressurised fluid at a fluid pressure of 1000 bar or higher. In other examples, the pressure vessel 1 is configured to store the pressurised fluid at a fluid pressure of 500 bar or higher.

The pressure vessel 1 comprises a shell 2 having two access ports 3. The access ports 3 are located at a neck 59 of the shell 2. Each access port 3 provides access to a storage space 41 for storing the pressurised fluid in the pressure vessel 1. In each of the access ports 3 a cap 5, 5′ is provided.

The pressure vessel 1, the shell 2, the access ports 3, and caps 5, 5′, are generally cylindrical.

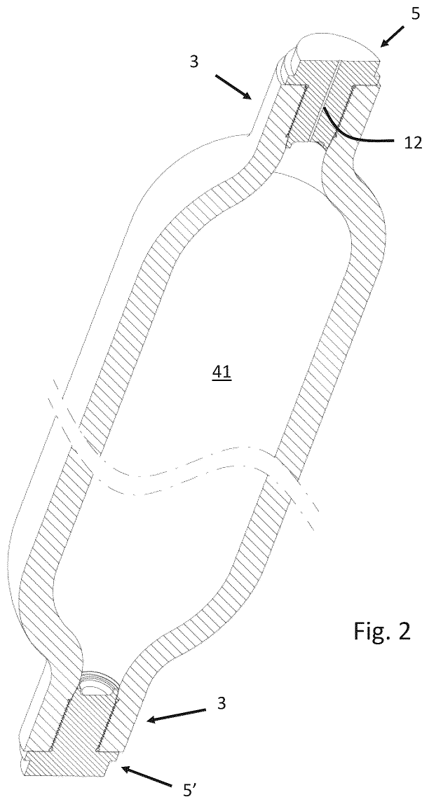

FIG. 2 shows a longitudinal section of the pressure vessel 1 of FIG. 1. The caps 5, 5′ are of similar construction. The only difference between the caps is that cap 5 comprises a duct 12, whereas cap 5′ is free from a duct. The access ports 3 are identical.

Each access port 3 is provided with a port sealing surface 4. Each cap 5, 5′ is provided with a cap sealing surface 6. The access ports 3 and the caps 5 are configured to receive and hold one of the caps 5 in one of the access ports 3 with the cap sealing surface 6 and the port sealing surface 4 contacting each other to form an internal seal 10.

The cap 5, 5′ extends in longitudinal (or axial) direction 46 along a (central) longitudinal axis 7. The cap 5, 5′ comprises an inner cap end 8 that is, when the cap 5, 5′ is mounted in the access port 3, situated inside the access port 3, and an outer cap end 51 that is located opposite to the inner cap end 8. The outer cap end 51 extends outside the access port 3. The cap 5, 5′ extends in longitudinal direction along the longitudinal axis 7 from the inner cap end 8 to the outer cap end 51.

A recess 9 is provided in the inner cap end 8 so as to form an annular axial extension 14. The axial extension 14, and an inner recess surface 11, form a boundary of the recess 9. The axial extension 14 extends from the inner recess surface 11.

A cap sealing surface 6 is provided at, in particular on, the axial extension 14. This allows to configure the seal parameters of the internal seal 10 independently of rest of the cap 5, more specifically independently of characteristics of the cap 5, such as specific dimensions (e.g. the diameter) of the cap body 17.

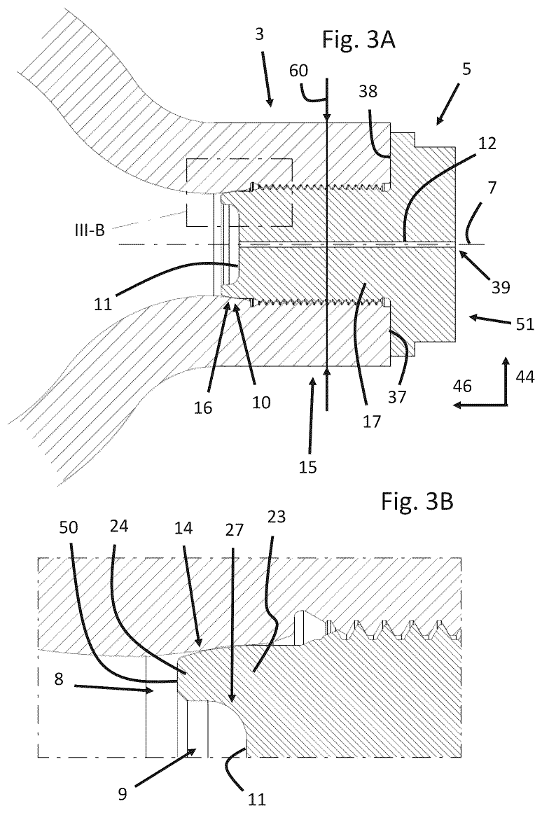

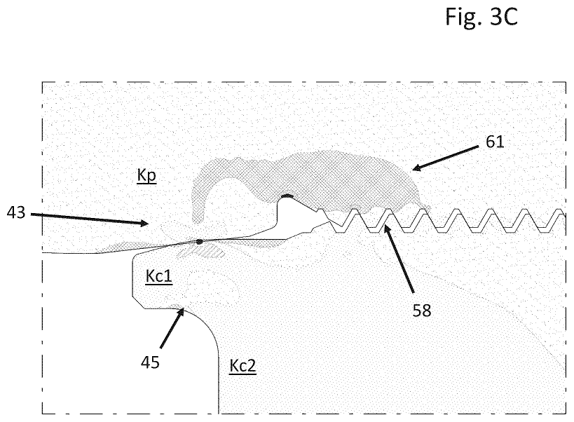

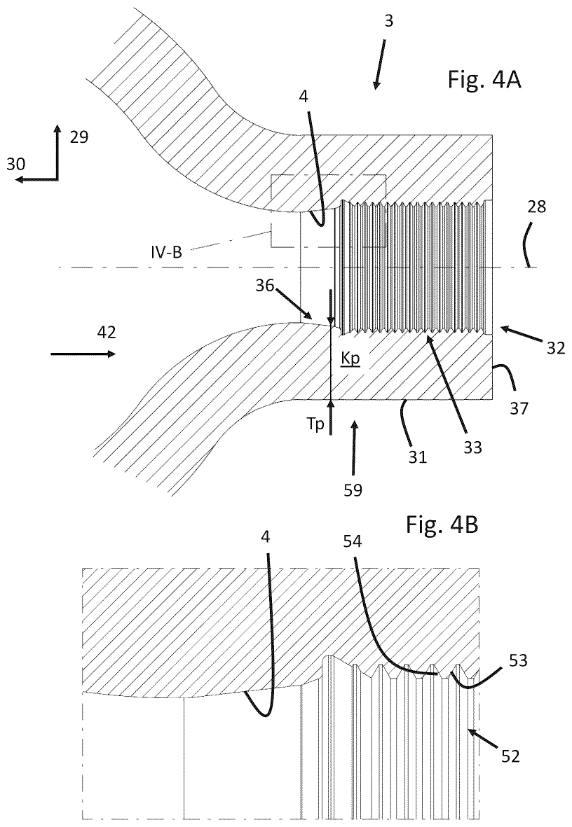

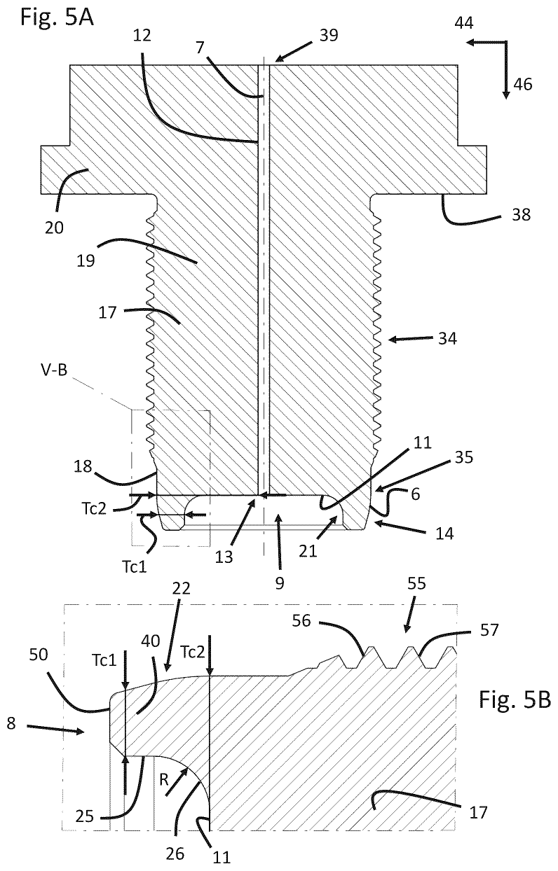

FIG. 3A shows a view in longitudinal section of the access port 3 and the cap 5 of the pressure vessel 1 shown in FIG. 1. FIG. 3B shows an enlarged view of part III-B of FIG. 3A. The axial extension 14 extends in axial direction 46 with respect to the longitudinal axis 7. The inner recess surface 11 extends transverse to the longitudinal axis 7. The duct 12 is configured to facilitate a flow of the pressurised fluid, such as hydrogen, in and/or out of the pressure vessel 1. A valve (not shown), such as a pressure valve, may be connected to the duct 12 in order to control the flow of pressurised fluid. The cap 5 comprises an outer duct opening 39 and the duct 12 extends from the inner duct opening 13 until the outer duct opening 39. The inner recess surface 11 is in radial direction 44 (see FIG. 5A) with respect to the longitudinal axis 7 located between the inner duct opening 13 and the axial extension 14. Further details of the access port 3 are shown in the FIGS. 4A and 4B. Further details of the cap are shown in the FIGS. 5A and 5B.

As mentioned, the cap 5 in FIG. 1 comprises a duct 12 having an inner duct opening 13 provided at the inner recess surface 11. The duct 12 is circular when viewed in a cross sectional view in a plane perpendicular to the longitudinal axis 7. The duct 12 extends along the longitudinal axis 7. The axial extension 14 extends away from the duct 12.

By providing the cap sealing surface 6 at the axial extension 14 extending from the inner recess surface 11 and away from the duct 12, it is possible to configure seal parameters independently of the duct 12, more specifically independently of characteristics of the duct 12, such as specific dimensions (e.g. the diameter) of the duct 12. This is possible because characteristics of the axial extension 14, such as specific dimensions (e.g. the cap extension thickness Tc1) of the axial extension 14 can be configured independently of the duct 12. As such, it is for example possible to adjust the flexibility in radial direction 44 of the axial extension 14 having the cap sealing surface 6, without influencing dimensions of the duct 12. Adjusting the flexibility of the axial extension 14 will lead to adjusted seal parameters of the internal seal 10 formed by the cap sealing surface 6 and the port sealing surface 4 contacting each other. This allows that seal parameters are selected which are favourable for reducing damage to the internal seal 10.

The internal seal 10 is a metal-to-metal seal 16. The metal-to-metal seal 16 is less susceptible to damage resulting from high temperatures when compared to elastomeric seals. As a result, the metal-to-metal seal 16 has a high thermal stability. The access port 3 and the cap 5 are free from an elastomeric seal.

The cap sealing surface 6 is axially spaced from the inner recess surface 11 when viewed along the longitudinal axis 7. The port sealing surface 4 is also axially spaced from the inner recess surface 11 when viewed along the longitudinal axis 7.

The axial extension 14 surrounds the inner duct opening 13 and is radially spaced from the inner duct opening 13. The axial extension 14 surrounds the longitudinal axis 7 completely.

The cap comprises a cap body 17 in which the duct 12 is provided. The cap body 17 comprises a circumferential cap surface 18 surrounding the longitudinal axis 7. The circumferential cap surface 18 has a circular cross section. The axial extension 14 comprises a cap extension thickness Tc1 measured in radial direction 44 with respect to the longitudinal axis 7 at the axial extension 14. The cap body 17 comprises a cap body thickness Tc2 measured in radial direction 44 with respect to the longitudinal axis 7 from the duct 12 until the circumferential cap surface 18. The cap extension thickness Tc1 is smaller than the cap body thickness Tc2. This allows that the axial extension 14 is constructed with a higher flexibility than the cap body 17 (see also FIG. 3C). This is beneficial to ensure that the seal parameters are mainly determined by the axial extension 14 when compared with the cap body 17. The axial extension 14 comprises a cap extension bending stiffness Kc1 at the cap extension thickness Tc1. The cap body 17 comprises a cap body bending stiffness Kc2 at the cap body thickness Tc2, and the cap extension bending stiffness Kc1 is smaller than the cap body bending stiffness Kc2.

The axial extension 14 comprises an adjoining end 23 adjacent to the inner recess surface 11 and a free end 24 axially distanced from the inner recess surface 11. The free end 24 terminates in an axial extension inner end surface 50. The inner end surface 50 is annular, and extends transverse with respect to the longitudinal axis 7. The inner end surface 50 is an end surface of the inner end 8 of the cap 5, 5′.

The cap extension thickness Tc1 is the smallest cap extension thickness Tc1 measured at the axial extension 14 in the radial direction 44. The smallest cap extension thickness Tc1 is measured at an extension part 40 of the axial extension 14 extending in axial direction 46 (see also FIG. 5B) from, and including, the cap sealing surface 6 until the adjoining end 23. The cap body thickness Tc2 is the smallest cap body thickness Tc2 measured at the cap body 17 from the duct 12 until the circumferential cap surface 18 in the radial direction 44. The smallest cap body thickness Tc2 is measured at the inner recess surface 11.

The access port 3 defines a further longitudinal axis 28 and the port sealing surface 4 faces towards the further longitudinal axis 28. The port sealing surface 4 surrounds the further longitudinal axis 28 completely.

The access port 3 comprises an outer port surface 31 and a port thickness Tp measured in a further radial direction 29 with respect to the further longitudinal axis 28 from the port sealing surface 4 until the outer port surface 31. The outer port surface 31 has a diameter 60 that is smaller than a largest outer diameter (not shown) of the shell 2. The further radial direction 29 and a further axial direction 30 with respect to the further longitudinal axis 28 are indicated in FIG. 4A. The port thickness Tp is larger than the cap extension thickness Tc1 mentioned above. This allows that the axial extension 14 is constructed with a higher flexibility than the access port 3. This is beneficial for the compressive hoop stresses provided on the axial extension 14 and the tensile hoop stresses on the access port 3 (see also FIG. 3C). In addition, this tends to ensure that if the internal seal 10 is damaged, the damage (or most of the damage) will occur at the cap 5, more specifically the axial extension 14 and the cap sealing surface 6, and not at the access port 3, more specifically the port sealing surface 4. The access port 3 comprises a port bending stiffness Kp at the port thickness Tp. The axial extension 14 comprises a cap extension bending stiffness Kc1 at the cap extension thickness Tc1. The port bending stiffness Kp is higher than the cap extension bending stiffness Kc1. The port thickness Tp is the smallest port thickness Tp measured at the access port 3 in the further radial direction 29. The smallest port thickness Tp is measured at the port sealing surface 4.

The axial extension 14 comprises an inner extension surface 25 facing towards the longitudinal axis 7 and a transition surface 26 connecting the inner extension surface 25 with the inner recess surface 11. The inner extension surface 25, the transition surface 26, and the inner recess surface 11 together form a boundary of the recess 9.

The transition surface 26 forms a rounded corner 27 extending along a radius R when seen in a longitudinal sectional view with respect to the longitudinal axis 7. This provides additional structural integrity to the axial extension 14. The transition surface 26 is provided directly opposite to the cap sealing surface 6.

The axial extension 14 and the cap body 17 are made from a same material, more specifically metal. The axial extension 14 and the cap body 17 are integrally formed (i.e. the axial extension 14 and the cap body 17 are made of a single piece). In other words; the axial extension 14 and the cap body 17 each are part of a single piece of material. The access port 3 and the axial extension 14 and made from the same material. The shell 2 of the pressure vessel 1 is made from the same material. The shell 2 and the access port 3 are integrally formed.

The access port 3 and the cap 5 are configured to hold the cap 5 in a sealing position 15 in the access port 3 with the cap sealing surface 6 and the port sealing surface 4 contacting each other to form the internal seal. The access port 3 comprises a port stop shoulder 37. The cap comprises a cap stop shoulder 38. The port stop shoulder 37 and the cap stop shoulder 38 are configured to contact each other, wherein, upon contact, the sealing surfaces 4, 6 are in contact to form the internal seal 10. In particular, the port stop shoulder 37 faces away from the shell 2, and the cap stop shoulder 38 faces towards the axial extension 14. The longitudinal axis 7 of the cap positioned in the sealing position 15 coincides with the further longitudinal of the access port 3.

As can be seen clearly in FIG. 3A, the port stop shoulder 37 is provided at a distance from the port sealing surface 4, wherein a female threaded zone 33 is provided between the port sealing surface 4 and the port stop shoulder 37. As such, shoulder contact tends to introduce tensional stresses, in particular in the cap 5, at a distance from the internal seal 10, rather than to introduce tensional stresses, in particular in the access port 3, next to the internal seal 10.

FIG. 3C shows the results of a finite element analysis of the situation of FIG. 3B, wherein the cap is positioned in the sealing position 15. FIG. 3C clearly shows that a first area 43 with the highest compression stresses caused in the access port 3 is much smaller than a second area 45 of the highest compression stresses in the cap 5. If the internal seal 10 is damaged by for example plastic deformation caused by high compression forces, the damage (or most of the damage) tends to occur at the cap 5, more specifically the axial extension 14. This is beneficial, because in practice it is cheaper to replace and/or repair the cap 5 rather than the shell 2 having the access port 3. Also, the highest tensional stresses in the access port 3 are present in the longitudinal section area 61 adjacent the threads, wherein in use this area 61 is sealed off from a fluid such as hydrogen kept in the storage space 41 of the vessel 1 by the internal seal 10.

The access port 3 comprises an outer access opening 32 and a female threaded zone 33. The cap 5 comprises a male threaded zone 34. The female threaded zone 33 and the male threaded zone 34 are configured for rotational engagement with each other. The female threaded zone 33 is located closer to the outer access opening 32 than the port sealing surface 4. The female threaded zone 33 and the male threaded zone 34 comprise non-tapered threads.

The female threaded zone 33 is located closer to the outer access opening 32 than the port sealing surface 4 when seen along the further longitudinal axis 28. The access port 3 and the cap 5 are free from a seal located closer to the outer access opening 32 than the female threaded zone 33. Hence, the access port 3 and the cap 5 are free from an external seal.

The female threaded zone 33 comprises a female thread 52. The female thread 52 comprises a female stab flank 53 and a female load flank 54. The male threaded zone 34 comprises a male thread 55. The male thread 55 comprises a male stab flank 56 and a male load flank 57. The female stab flank 53 faces towards the outer access opening 32, and the female load flank 54 faces away from the outer access opening 32. The male stab flank 56 faces towards the inner cap end 8. As can be seen in FIG. 3C, when the cap 5 has been made up with the access port 3, the stab flanks 53, 56 are located at a distance 58 from each other, whereas the load flanks 54, 57 are in contact with each other. The internal seal 10 seals the access port 3 of the pressure vessel 1 such that hydrogen contained in the storage space 41 cannot reach the threaded zones 33, 34.

The cap 5 comprises an inner cap section 19 configured to be located inside the access port 3 and an outer cap section 20 configured to be located outside the access port 3. The axial extension 14 and the cap body 17 are part of the inner cap section 19. The inner duct opening 13 is located at the inner cap section 19 and the outer duct opening 39 is located at the outer cap section 20. The axial extension 14 extends away from the outer cap section 20.

The axial extension 14 is annular. The axial extension 14 comprises an inner extension side 21 facing towards the longitudinal axis 7 and an outer extension side 22 facing away from the longitudinal axis 7. The cap sealing surface 6 is located at the outer extension side 22. The cap sealing surface 6 surrounds the longitudinal axis 7 completely.

The cap sealing surface 6 is toroidal 35. The port sealing surface 4 is conical 36. The conical 36 port sealing surface 4 becomes wider in a first direction 42 along the further longitudinal axis 28 of the access port 3 and towards the outer access opening 32.

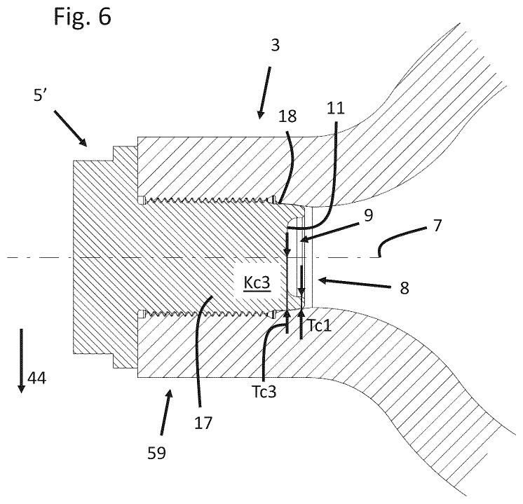

FIG. 6 shows a view in longitudinal section of the access port 3 and the cap 5′ of the pressure vessel 1 in FIG. 1. The only difference with respect to the access port 3 at the opposite end of the pressure vessel 1 holding cap 5 as shown in the FIGS. 3A-C, 4A-B, and 5A-B, is that cap 5′ does not have a duct 12.

Similar to cap 5, the axial extension 14 of the cap 5′ surrounds the longitudinal axis 7 and is radially spaced from the longitudinal axis 7.

The cap body 17 of the cap 5′ comprises a further cap body thickness Tc3 measured in radial direction 44 with respect to the longitudinal axis 7 from the longitudinal axis 7 until the circumferential cap surface 18. The cap extension thickness Tc1 (as described above in relation to cap 5) is smaller than the further cap body thickness Tc3. This allows that the axial extension 14 is constructed with a higher flexibility than the cap body 17. This is beneficial to ensure that the seal parameters are mainly determined by the axial extension 14 when compared with the cap body 17.

The cap body 17 comprises a further cap body bending stiffness Kc3 at the further cap body thickness Tc3, and the cap extension bending stiffness Kc1 (as described above in relation to the cap 5) is smaller than the further cap body bending stiffness Kc3.

The further cap body thickness Tc3 is the smallest further cap body thickness Tc3 measured at the cap body 17 from the longitudinal axis 7 until the circumferential cap surface 18 in the radial direction 44. The smallest further cap body thickness Tc3 is measured at the inner recess surface 11.

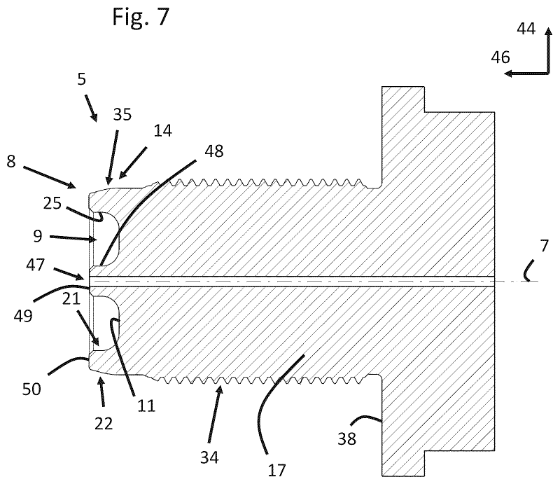

FIG. 7 shows another embodiment of the cap 5 in accordance with the present invention in longitudinal section. Similar to the embodiment of FIG. 5A, the cap 5 comprises at the inner cap end 8 thereof a recess 9. However, different from the above described cap 5, the recess 9 has an annular shape, wherein an annular recess surface 11 is formed. The annular recess 9 is bound in radial direction by the axial extension 14; and by a central part 47 of the inner cap end 8, in particular by an outer side 48 of the central part 47 of the inner cap end 8. The annular recess 9 is bound in longitudinal direction by the inner recess surface 11. The outer side 48 faces away from the longitudinal axis 7. The duct opening 13 is provided in an inner cap end surface 49 of the central part 47 of the inner cap end 8. The inner cap end surface 49 is transverse with respect to the longitudinal axis 7. The inner cap end surface 49 and the axial extension inner end surface 50 of the axial extension 14 lie in the same transverse plane with respect to the longitudinal axis 7. As such, the axial extension 14 and the central part 47 are flush to each other in axial direction 46. It is, however, envisioned that the central part 47 can extend, in axial direction, more or less than the axial extension 14. An advantage of this embodiment is, that the inner extension side 21 may be safeguarded from turbulent fluid flows.

The longitudinal sections shown in the Figures are taken at longitudinal axis 7 and/or further longitudinal axis 28. Cross sections are taken in a plane perpendicular to the longitudinal axis 7 and/or further longitudinal axis 28.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

It will be apparent to those skilled in the art that various modifications can be made to the pressure vessel according to the invention, the method according to the invention, and the cap according to the invention shown in the figures without departing from the scope as defined in the claims.

1. A pressure vessel for storing a pressurised fluid, the pressure vessel comprising:
a shell comprising an access port provided with a port sealing surface, and
a cap provided with a cap sealing surface and defining a longitudinal axis, wherein:
the access port and the cap are configured to receive and hold the cap in the access port with the cap sealing surface and the port sealing surface contacting each other to form an internal seal,
the cap comprises an inner cap end,
a recess is provided in the inner cap end, such that an axial extension is formed, and
the cap sealing surface is provided at the axial extension.

2. Pressure vessel of claim 1, wherein the axial extension surrounds the recess.

3. Pressure vessel of claim 1, wherein the cap comprises a duct having an inner duct opening, and the axial extension is radially spaced from the inner duct opening.

4. Pressure vessel of claim 1, wherein:
the cap comprises a cap body,
the cap body comprises a circumferential cap surface surrounding the longitudinal axis,
the axial extension comprises a cap extension thickness measured in radial direction with respect to the longitudinal axis at the axial extension,
the cap body comprises a cap body thickness measured in radial direction with respect to the longitudinal axis between the longitudinal axis and the circumferential cap surface, and
the cap extension thickness is smaller than the cap body thickness.

5. Pressure vessel of claim 1, wherein the axial extension further comprises an outer extension side facing away from the longitudinal axis and the cap sealing surface is located at the outer extension side.

6. Pressure vessel of claim 1, wherein the cap comprises an inner recess surface, and the axial extension comprises an inner extension surface facing towards the longitudinal axis and a transition surface connecting the inner extension surface with the inner recess surface, and the transition surface forms a rounded corner extending along a radius R when seen in a longitudinal sectional view with respect to the longitudinal axis.

7. Pressure vessel of claim 1, wherein the access port defines a further longitudinal axis and the port sealing surface faces towards the further longitudinal axis.

8. Pressure vessel of claim 1, wherein:
the axial extension comprises a cap extension thickness measured in radial direction with respect to the longitudinal axis at the axial extension,
the access port comprises an outer port surface and a port thickness measured in a further radial direction with respect to the further longitudinal axis between the port sealing surface and the outer port surface, and
the port thickness is larger than the cap extension thickness.

9. Pressure vessel of claim 1, wherein:
the access port comprises an outer access opening and a female threaded zone,
the cap comprises a male treaded zone,
the female threaded zone and the male threaded zone are configured for rotational engagement with each other, and
the female threaded zone is located closer to the outer access opening than the port sealing surface.

10. Pressure vessel of claim 9, wherein the access port and the cap are free from a seal located closer to the outer access opening than the female threaded zone.

11. Pressure vessel of claim 1, wherein the cap sealing surface is toroidal.

12. Pressure vessel of claim 1, wherein the access port and the cap are free from an elastomeric seal.

13. A method for sealing a pressure vessel for storing a pressurised fluid of claim 1, the method comprising placing the cap in the access port and forming an internal seal with the cap sealing surface and the port sealing surface contacting each other.

14. A cap for a pressure vessel, comprising:
an inner cap end,
a recess provided in the inner cap end, such that an axial extension is formed, and
a cap sealing surface provided at the axial extension.
